(19) United States
(12) Patent Application Publication
(10) Pub. No.: US 2006/0170212 A1
(43) Pub. Date: Aug. 3, 2006

(54) Automatically-extractable coupling device

(75) Inventor: Nicolas Le Bars, Thorigne (FR)

Correspondence Address: YOUNG & THOMPSON, 745 SOUTH 23RD STREET, 2ND FLOOR, ARLINGTON, VA, 22202, US

(73) Assignee: LEGRIS SA, RENNES (FR)

(21) Appl. No.: 11/339,491

(22) Filed: Jan. 26, 2006

(30) Foreign Application Priority Data
Jan. 28, 2005 (FR) 05 00907

(51) Int. Cl. F16L 37/00

(52) U.S. Cl. 285/308

(57) ABSTRACT

A coupling device for coupling a pipe end to a channel end opening out into a surface of a circuit element, the device including a tubular body having a first end provided with elements for anchoring it in the channel end, and a second end for projecting from the surface of the circuit element in order to be coupled to the pipe end. The anchor elements include an anchor washer and a socket bearing against the surface of the circuit element, the socket slidably receiving the body between an operating position and a disassembly position. The socket, the washer, and the body are arranged so that, in the disassembly position, the body constitutes elements for extracting the coupling device from the channel.

The present invention relates to an automatically-extractable coupling device suitable for coupling the end of a pipe to a circuit element such as a fluid emitter or receiver element, and constituted, for example, by an other pipe, a pump, a manifold, an actuator, a valve . . .

### BACKGROUND OF THE INVENTION

A device for coupling a pipe end to a channel end in a circuit element, generally comprises a tubular body having a first end provided with means for anchoring it in said channel end, and a second end provided with a housing for receiving the pipe end and means for securing the pipe end therein in leaktight manner.

Document FR-A-2 810 087 discloses such a coupling device in which the anchor means are constituted by an anchor washer having an outer circumference that is subdivided into a plurality of teeth for catching in the wall of the channel end.

When the channel end is tapped, the teeth of the anchor washer are arranged so as to bear against a portion of the thread of the tapping (as in the above-mentioned document), and when the coupling end is smooth, the teeth of the washer are arranged to penetrate into the wall of the channel end.

That structure enables the coupling device to be engaged quickly and reliably with the circuit element. Nevertheless, such coupling devices present the drawback of being difficult or impossible to disassemble. When they are suitable for being disassembled, it is necessary to use a tool in order to extract them: for tapped channel ends, the body generally has a polygonal section enabling the coupling device to be unscrewed by means of a wrench; for smooth channel ends, the disassembly tool could be a dedicated tool inserted between the wall of the channel end and the body of the coupling device in order to deform the washer in such a manner as to allow the coupling device to be extracted. Having recourse to a tool under such conditions makes disassembly relatively difficult and can lead to the device being damaged, particularly when the operator does not have the appropriate tool available. It is also necessary at the time the circuit element is designed to provide sufficient empty space around the outlet of the channel for passing the tool for disassembling the coupling device. Such a constraint can lead to the circuit element being relatively bulky.

### OBJECT OF THE INVENTION

It would therefore be advantageous to have means for facilitating disassembly of such coupling devices.

### BRIEF SAY OF THE INVENTION

According to the invention, there is provided a coupling device for coupling a pipe end to a channel end opening out into a surface of a circuit element, the device comprising a tubular body having a first end provided with means for anchoring it in said channel end, and a second end for projecting from said surface of the circuit element in order to be coupled to the pipe end. The anchor means comprise an anchor washer and a socket bearing against said surface of the circuit element, the socket slidably receiving the body between an operating position and a disassembly position. The socket, the washer, and the body are arranged so that, in the disassembly position, the body constitutes means for extracting the coupling device from the channel.

Thus, when the body is in the operating position, the device provides coupling in conventional manner between the pipe end and the channel in the circuit element. The ability of the body to move axially relative to the socket makes it possible to bring the body into a disassembly position in which the body enables the coupling device to be extracted from the channel end. There is then no need to use a tool during extraction.

Advantageously, the anchor washer is elastically deformable between an open state and a closed state. It is mounted on the body, and the socket includes an axial abutment portion for engaging the teeth of the anchor washer for holding the washer in one of its states.

Such an arrangement makes it possible to have a coupling device suitable for being anchored in a channel that is smooth or a channel that is tapped.

In a first embodiment, the anchor washer is at rest when it is in its open state, and:

when the body is in its operating position, the anchor washer is disengaged from the abutment portion;

when the body is in its disassembly position, the washer is pressed against the abutment portion, which holds the washer in its closed state.

In a second embodiment, the anchor washer is at rest when it is in its closed state, and:

when the body is in the operating position, the anchor washer is pressed against the abutment portion, which holds the anchor washer in its open state; and

when the body is in the disassembly position, it is constrained in rotation with the socket.

Thus, when the body is in the disassembly position, it is possible to unscrew the coupling device by causing its body to turn.

Other characteristics and advantages of the invention appear on reading the following description of particular, non-limiting embodiments of the invention.

### BRIEF DESCRIPTION OF THE DRAWINGS

Reference is made to the accompanying drawings, in which:

FIG. 1 is a longitudinal section view of a coupling device constituting a first embodiment, the device being shown with the body in the operating position;

FIG. 2 is a detail view of zone II of FIG. 3;

FIG. 3 is a view analogous to FIG. 1 showing the first embodiment of the coupling device of the invention when the body is in the disassembly position;

FIG. 4 is a plan view of the coupling device;

FIG. 5 is a plan view of a coupling device constituting a second embodiment;

FIGS. 6 and 7 are view analogous to FIGS. 1 and 3 of the second embodiment of the coupling device;

FIG. 8 is a view analogous to that of FIG. 1 showing a coupling device constituting a third embodiment; and

FIGS. 9 and 10 are view analogous to FIGS. 1 and 3 of a coupling device constituting a fourth embodiment.

### DETAILED DESCRIPTION OF THE INVENTION

With reference to the figures, the device in accordance with the invention is arranged to connect a pipe end (not shown in the figures) to a circuit element. The coupling device is designed to be mounted on a circuit element, given overall reference 1, that includes a channel presenting an end 2 that opens out into a surface 3 of the circuit element 1. The circuit element 1 may be a fluid emitter or receiver element, such as another pipe, a pump, a manifold, an actuator, a valve . . . .

The coupling device in accordance with the invention, given overall reference 10, comprises a tubular body given overall reference 11, which in this case presents the shape of a 90° bend.

The tubular body 11 has a first end 12 provided with means, given overall reference 13, for anchoring it in the channel end 2, and a second end 14 provided with a housing for receiving the pipe end together with means, given overall reference 15, for securing it in leaktight manner to the pipe end. The leaktight retaining means 15 in this embodiment are instantaneous connection means of a kind that is known in itself (see for example document FR-A-2 810 087) and they are not described in detail herein. These retaining means could equally well be constituted by non-instantaneous connection means.

The anchor means 13 comprise an anchor washer 16 and a socket given overall reference 17 that bears against the surface 3 of the circuit element 1.

The anchor washer 16 possesses an outer circumference that is subdivided into a plurality of teeth 18 arranged in such a manner that the anchor washer 16 is elastically deformable between an open state in which the anchor washer 16 has an outside diameter greater than the inside diameter of the channel end 2, and a closed state in which the anchor washer 16 has an outside diameter smaller than the inside diameter of the channel end 2.

The anchor washer 16 is received in an outer groove 19 formed in the end 12 of the tubular body 11.

The socket 17 comprises a bushing 20 having a first end 21 for insertion into the channel end 2, and a second end 22 for projecting out therefrom.

On the outside, between its two ends 21 and 22, the bushing 20 is provided with a collar 23 having a bottom surface designed to bear against the surface 3 of the circuit element 1. The bottom surface of the collar 23 is provided with a plane groove receiving an annular and deformable sealing element 24 in conventional manner.

The tubular body 11 is slidably received in the bushing 20 of the socket 17 to slide between an operating position and a disassembly position which are described in greater detail below for each of the embodiments.

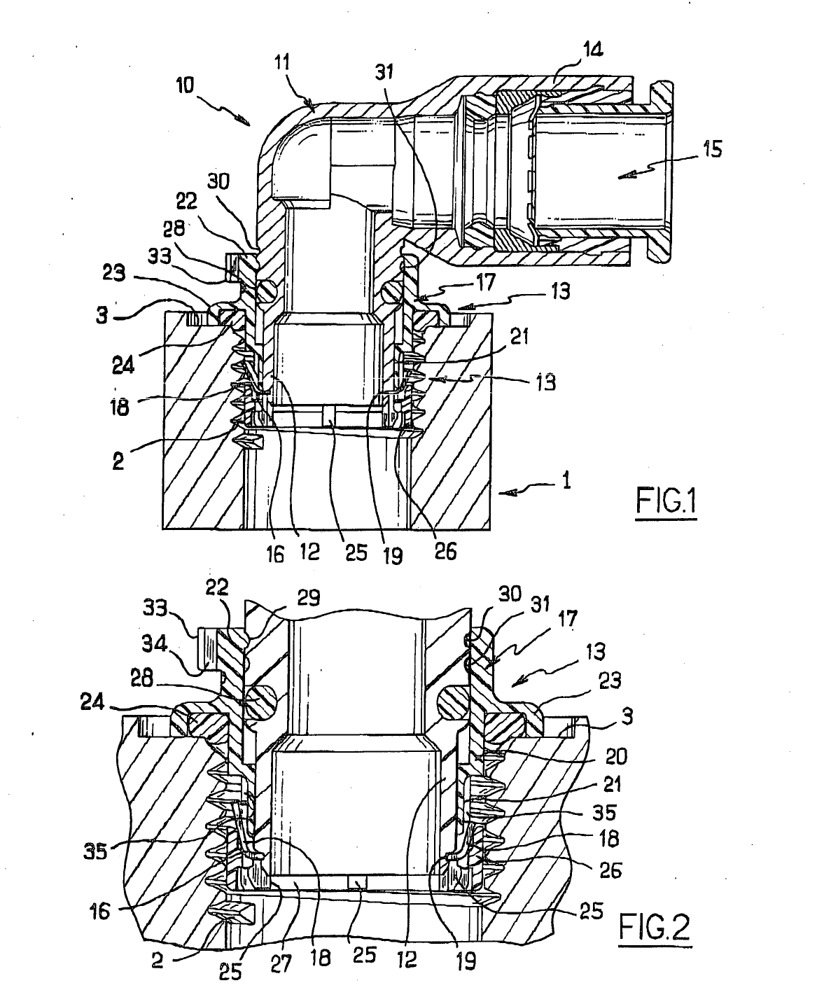

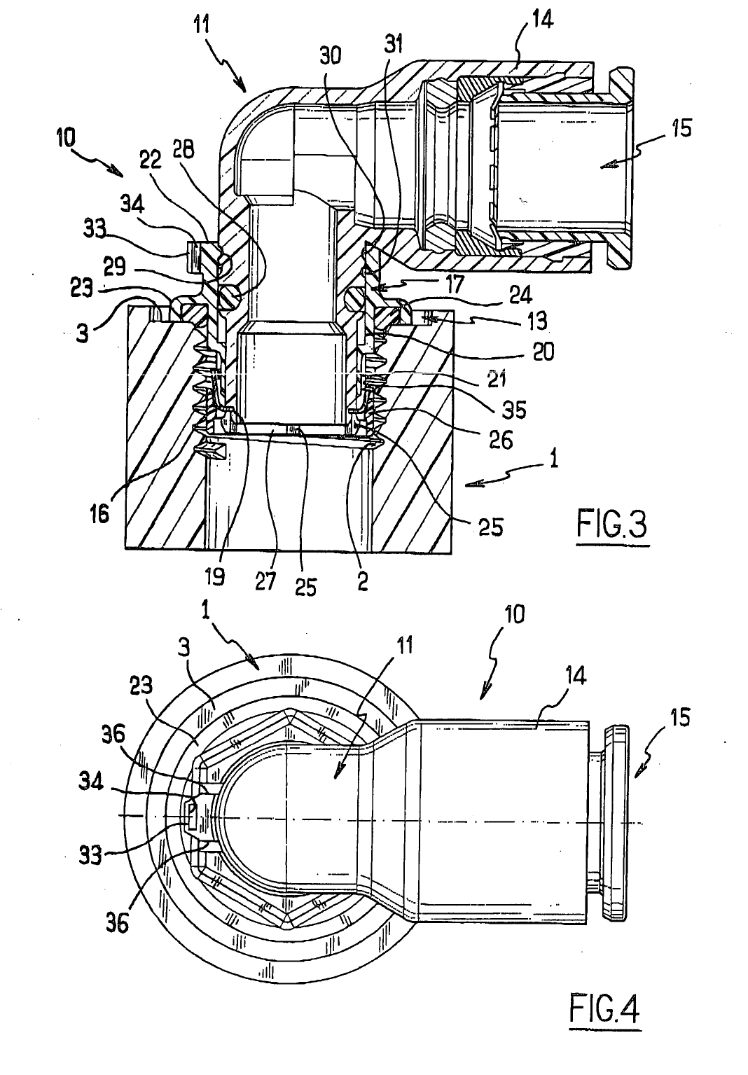

With reference to FIGS. 1 to 4, in the first embodiment, when the anchor washer 16 is at rest it is in its open state.

The bushing 20 has arms 25 projecting axially from its end 21 so as to have a free end onto which there can be clipped a ring 26 that is internally chamfered beside the bushing 20. Between one another, the arms 25 define slots 27.

In the operating position, the anchor washer 16 is in its open state and has its teeth 18 projecting out from the bushing 20 via the slots 27.

In the disassembly position, the tubular body 11 is pushed into the bushing 20 in such a manner that the anchor washer 16 comes into register with the ring 26 so that its chamfered portion forms an axial abutment for the teeth 18 and deforms the teeth 18, thereby holding the anchor washer 16 in its closed state.

An annular and deformable sealing element 28 is received in an outer groove in the tubular body 11 so as to be pressed against the inside surface of the bushing 20.

The coupling device further comprises a retaining member for retaining the tubular body 11 in its two positions. The retaining member has a stud 29 projecting inwards from an elastically deformable blade defined by two parallel slots 36 formed in the end 22 of the socket 17, and two grooves 30 and 31 for receiving the stud 29 when the tubular body 11 is in the operating position and in the disassembly position, respectively. A projection 33 projects outwards from the end 22 in the opposite direction to the stud 29. The projection 33 is provided with a slot 34 suitable for receiving a screwdriver blade or some other tool of the same type. The elastically deformable blade is deformable between a position in which the stud is received in one of the grooves, and a position in which the stud is disengaged from any groove. The retaining means formed in this way are thus deactivatable.

The coupling device 10 is put into place on the circuit element 1 while the tubular body 11 is in the operating position.

The end 12 of the tubular body 11 is then inserted directly into the channel end 2 until the bearing face of the collar 23 of the socket 17 comes into abutment against the face 3 of the circuit element 1. The teeth 18 deform towards the closed state of the anchor washer 16 and remain pressed against the wall of the channel end 2. When the channel end is tapped, as shown in the figures, it is possible to screw the socket 17 in to a small extent in order to improve its retention. This is possible because of the presence of fluting 35 on the end 21 of the socket 17 with the teeth 18 being received therein. When turning movement is imparted to the socket 17 (e.g. by means of a wrench acting on a polygonal section of the socket), the fluting co-operates with at least a portion of some of the teeth 18 so as to turn the washer 16.

Any extraction force exerted on the tubular body then causes the teeth of the anchor washer 16 to jam, with the teeth 18 bearing against the thread of the taping (for a channel end that is tapped, as shown in the figures). This jamming of the teeth 18 opposes any withdrawal of the coupling device 10.

Extraction is achieved by deforming the resilient blade provided with the stud 29, e.g. by using a screwdriver engaged in the slot 34 as a lever to extract the stud 29 from the groove 30 while pushing the tubular body 11 into the disassembly position. The anchor washer is then brought and held into its closed state by the ring 26. When the resilient blade is released, the stud 29 comes into the groove 31 so as to hold the tubular body 11 in the disassembly position. In the disassembly position, a portion of the tubular body 11, notably its bent central portion and its extremity 14, remains projecting from socket 13 and from channel end 2 thus permitting the prehension of the tubular body 11. By pulling on the tubular body 11, it is then possible to extract the coupling device.

Elements identical or analogous to those described above are given the same references in the following description of other embodiments.

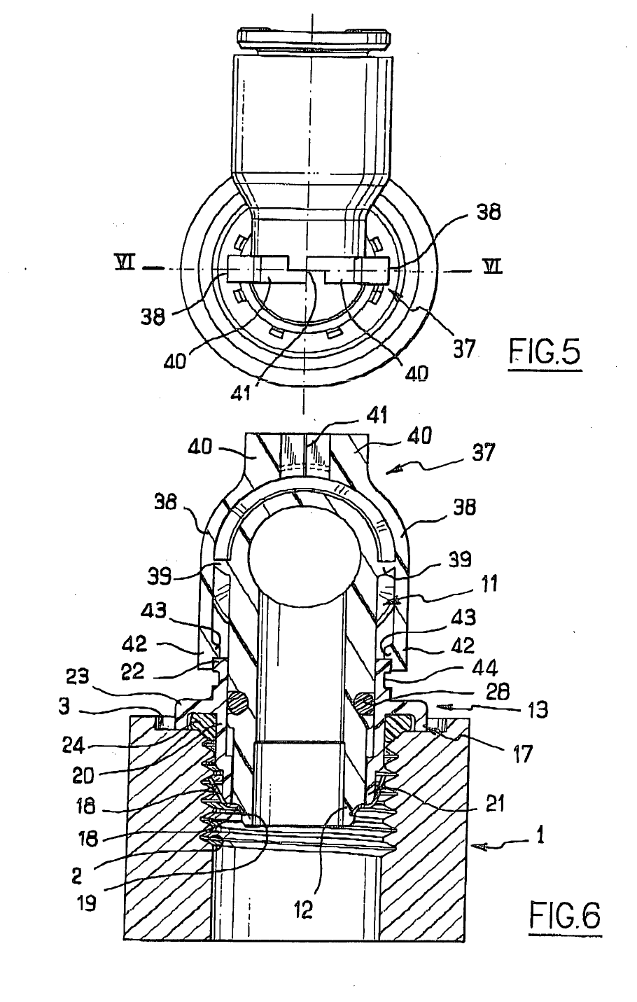

With reference to FIGS. 5 to 7, in the second embodiment of the invention, the anchor washer 16 is no longer at rest in its open state, but rather in its closed state. The end 21 of the bushing 20 of the socket 17 no longer has arms 25 or a ring 26, and the end 12 of the tubular body 11 projects from the end 21 of the bushing 20.

When the tubular body 11 is in its operating position, the teeth 18 of the anchor washer 16 press against the end 21 of the bushing 20 which constitutes an axial abutment for the teeth 18 and holds the anchor washer 16 in its open state.

When the tubular body 11 is in its disassembly position, the teeth 18 of the anchor washer 16 escape from pressing against the end 21 of the bushing 20, and the anchor washer 16 is in its closed state.

The tubular body 11 is also provided with a retaining member for retaining the tubular body 11 in the operating position and in the disassembly position. This member, given overall reference 37, is in the form of a fork having two limbs 38 each having a central portion connected to the tubular body 11 via a deformable tab 39, each having top ends 40 held apart from each other by a spacer 41 presenting a line of weakness, and opposite, bottom ends 42 each provided with an inwardly-directed step 43 arranged to bear against an end face of the end 22 of the bushing 20 when the tubular body 11 is in the operating position and in order to be received in an outer groove 44 of said end when the tubular body 11 is in the disassembly position.

The coupling device 10 is put into place on the circuit element 1 in the same manner as described above.

In order to extract the coupling device 10, it is necessary to cause the top ends 40 of the fork 37 to move towards each other by breaking the spacer 41 in such a manner as to cause the steps 43 at the bottom ends 42 to disengage from bearing against the end face of the end 22 of the bushing 20. Thereafter, the tubular body 11 should be pushed into its disassembly position until the steps 43 at the bottom ends 42 of the fork 37 can be received in the groove 44. During this pushing movement, the teeth 18 of the anchor washer 16 cease to press against the end 21 of the bushing 20 so that the teeth 18 return resiliently into their rest position: the anchor washer 16 is then in its closed position. It is then possible to exert a traction force on the projecting portion of the tubular body 11 in order to extract the coupling device 10 from the channel end 2. The fork 37 then provides an axial connection between the tubular body 11 and the socket 17. The anchor washer 16 also provides an axial connection between the tubular body 11 and the socket 17, the teeth 18 of the anchor washer 16 in the closed state also entraining the socket 17 by bearing against the end 21 (in the absence of resistance to extraction, the extraction force is insufficient to deform the teeth 18 and bring the anchor washer 16 into its open state).

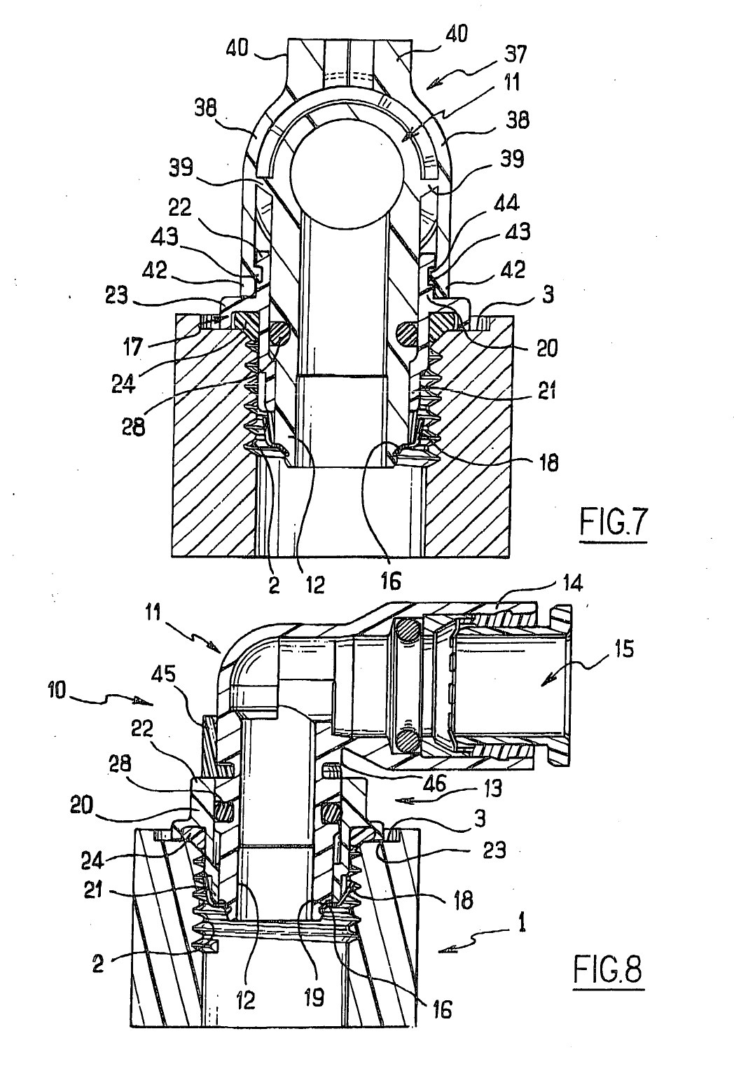

With reference to FIG. 8, in the third embodiment, the coupling device 10 is identical to the second embodiment except for the retaining means for retaining the tubular body 11 in its two positions.

The coupling device 10 of the third embodiment only has means for retaining the tubular body 11 in its operating position. These means comprise a resilient split ring 45 releasably received in a groove 46 formed in the outside of the tubular body 11 so that in the operating position the resilient split ring 45 projects from the tubular body and bears axially against the end 22 of the socket 17 so as to oppose the tubular body 11 being pushed towards its disassembly position.

In order to extract the coupling device 10, the resilient split ring 45 is removed before the tubular body 11 is put into its disassembly position. Thereafter the extraction operation is continued in the same manner as for the second embodiment.

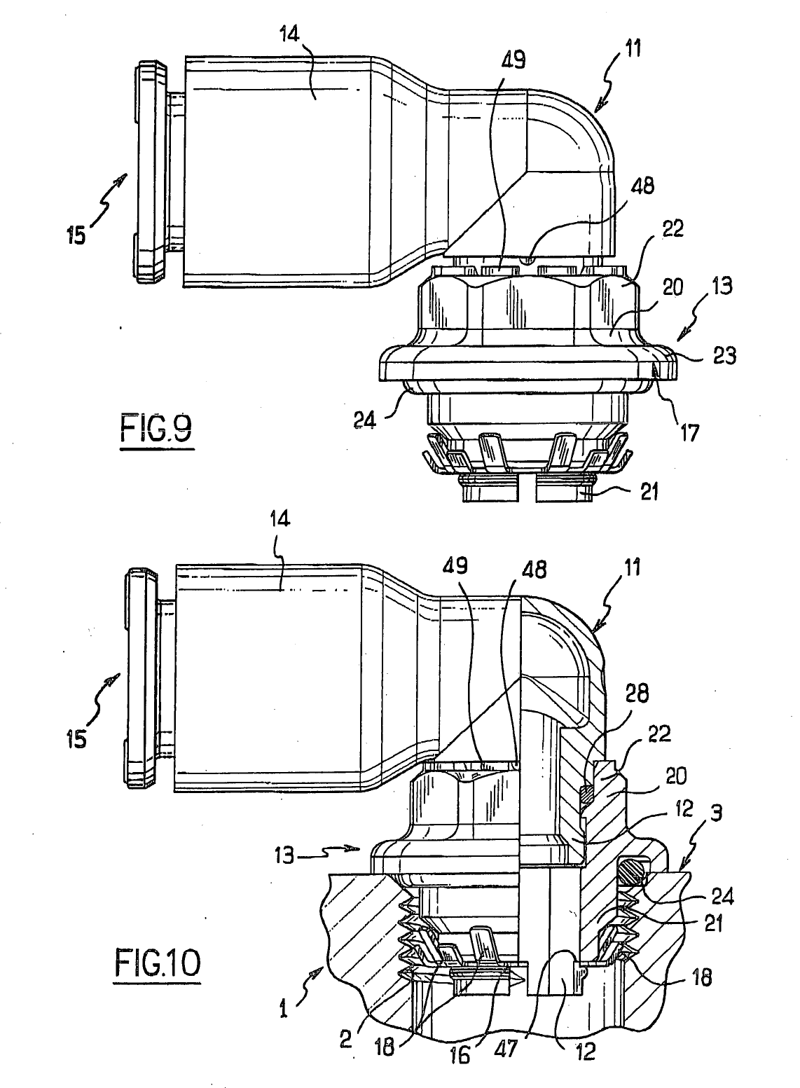

With reference to FIGS. 9 and 10, in the fourth embodiment, the anchor washer 16 is received in an outer groove 47 in the end 21 of the bushing 20 of the socket 17 and is constrained in rotation relative to said end 21 (for example the anchor washer 16 may include an inwardly-directed tooth received in a slot in the end 21).

The tubular body 11 and the socket 17 have complementary positive coupling means arranged in such a manner as to be disengaged from each other when the tubular body 11 is in the operating position (the tubular body 11 is then free to turn relative to the socket 17), and that co-operate with each other when the tubular body 11 is in the disassembly position (the tubular body 11 is then constrained in rotation relative to the socket 17). These complementary positive coupling means comprise axial projections 48 arranged on the tubular body 11 and axial setbacks 49 formed in the end 22 of the bushing 20 of the socket 17 in order to receive the axial projections 48 of the tubular body 11 when it is in the disassembly position.

The coupling device 10 is put into position in the same manner as for the above-described embodiment.

Disassembly is performed by bringing the tubular body 11 into its disassembly position and by causing it to turn in such a manner as to unscrew the coupling device 10.

It should be observed that the annular and deformable sealing element 28 is interposed between two shoulders, one belonging to the tubular body 11 and the other to the bushing 20. The sealing element 28 performs a resilient return function urging the tubular body 11 towards the operating position. In addition, when the circuit in which the coupling device is installed is under pressure, the fluid under pressure pushes the tubular body 11 towards the operating position.

Naturally, the invention is not limited to the embodiments described and variant embodiments could be applied thereto without going beyond the ambit of the invention as defined by the claims.

In particular, although the sealing element between the socket and the body is used in the fourth embodiment described above for resiliently returning the body to the operating position, it is possible to use a dedicated return member such as a helical compression spring interposed between the body and the socket, or elastically deformable tabs secured to the body or the socket in order to press against the socket or the body and push those two elements apart from each other.

Although the retaining member in some of the above-described embodiments is formed by a fork (second embodiment), a radially movable latch (first embodiment), or a stop segment (third embodiment), it is also possible to provide a frangible abutment between the body and the socket that opposes movement of the body towards its disassembly position, at least until a force has been exerted thereon that is sufficient to break it. The retaining means may also be embodied in the form of a stud secured to the socket or the tubular body so as to be received in a bayonet groove having a central segment that extends axially and two end segments that extend in circumferential directions.

Furthermore, the tubular body may be rectilinear or may constitute a bend through an angle other than 90°.

The anchor washer may be arranged so that its teeth bite into the wall of the channel end 2 (assuming that the channel end is smooth).

The positive coupling means may comprise a male hexagonal section at the end 12 of the tubular body 11 and a female hexagonal section of the socket.

It is also possible to combine the various embodiments described above.

Although in the embodiments described, the end 14 of the tubular body 11 is provided with means for receiving the pipe end in leaktight manner, the end 14 could be designed for insertion into connection means themselves secured to the pipe end. The end 14 may be smooth on the outside or it may be provided with a groove or a bead.

What is claimed is:

1. A coupling device for coupling a pipe end to a channel end opening out into a surface of a circuit element, the device comprising a tubular body having a first end provided with means for anchoring it in said channel end, and a second end for projecting from said surface of the circuit element in order to be coupled to the pipe end, wherein the anchor means comprise an anchor washer and a socket bearing against said surface of the circuit element, the socket slidably receiving the body between an operating position and a disassembly position, and wherein the socket, the washer, and the body are arranged so that, in the disassembly position, the body constitutes means for extracting the coupling device from the channel.

2. A device according to claim 1, wherein the anchor washer is elastically deformable between an open state and a closed state, wherein the anchor washer is mounted on the body, and wherein the socket includes an axial abutment portion for engaging the teeth of the anchor washer to hold the anchor washer in one of its states.

3. A device according to claim 2, wherein the anchor washer is at rest when in its open state, and wherein:
when the body is in its operating position, the anchor washer is disengaged from the abutment portion; and
when the body is in its disassembly position, the washer is pressed against the abutment portion, which holds the washer in its closed state.

4. A device according to claim 2, wherein the anchor washer is at rest when it is in its closed state, and wherein:
when the body is in the operating position, the anchor washer is pressed against the abutment portion, which holds the anchor washer in its open state; and
when the body is in the disassembly position, the anchor washer is disengaged from the abutment portion.

5. A device according to claim 1, wherein the body is pushed into the disassembly position, and wherein the device includes a retaining element for holding the body in the disassembly position, the retaining element extending between the body and the socket.

6. A device according to claim 1, wherein the anchor washer is mounted on the socket and is constrained to turn therewith, and wherein:
when the body is in the operating position, it is free to turn relative to the socket; and
when the body is in the disassembly position, it is constrained in rotation with the socket.

7. A device according to claim 6, wherein the socket and the body include complementary positive coupling means arranged to co-operate when the body is in the disassembly position.

8. A device according to claim 1, including resilient return means for urging the body towards the operating position.

9. A device according to claim 8, wherein the resilient return means comprise an elastically deformable annular sealing element interposed between two axial bearing portions, one belonging to the socket and the other to the body.

10. A device according to claim 1, including deactivatable retaining means for holding the body in the operating position.

11. A device according to claim 1, wherein the second end of the tubular body is provided with a housing for receiving the pipe end, and for receiving means for retaining the pipe end therein in leaktight manner.

12. A device according to claim 1, wherein the second end is arranged to be engaged in connection means of the pipe end.
